(19) United States
(12) Patent Application Publication
(10) Pub. No.: US 2025/0378781 A1
(43) Pub. Date: Dec. 11, 2025

(54) DISPLAY APPARATUS AND ELECTRONIC APPARATUS INCLUDING THE SAME

(71) Applicant: Samsung Display Co., LTD., Yongin-si (KR)

(72) Inventors: SEHYUN LEE, Yongin-si (KR); KWIHYUN KIM, Yongin-si (KR); DONGWOO KIM, Yongin-si (KR); DOYEONG PARK, Yongin-si (KR); KIHYUN PYO, Yongin-si (KR)

(21) Appl. No.: 19/078,543

(22) Filed: Mar. 13, 2025

(30) Foreign Application Priority Data
Jun. 7, 2024 (KR) 10-2024-0074236

(51) Int. Cl. G09G 3/32

(52) U.S. Cl. CPC G09G 3/32; G09G 2300/0819; G09G 2310/0267; G09G 2310/0275; G09G 2310/08; G09G 2320/0626; G09G 2330/021

(57) ABSTRACT

A display apparatus includes a display panel including a plurality of pixels, a gate driver configured to output a gate signal to the display panel, an emission driver configured to output an emission signal to the display panel, a data driver configured to apply a data voltage to the display panel and a driving controller configured to control the gate driver, the emission driver and the data driver. In a state in which a setting luminance of the display panel has a second setting luminance lower than a first setting luminance, an emission period in which the pixels emit has a second emission period length longer than a first emission period length. An on-pixel ratio of the pixels is changed based on the setting luminance.

This application claims priority to Korean Patent Application No. 10-2024-0074236, filed on Jun. 7 2024, and all the benefits accruing therefrom under 35 U.S.C. § 119, the content of which in its entirety is herein incorporated by reference.

### BACKGROUND

### 1. Field

Embodiments of the inventive concept relate to a display apparatus and an electronic apparatus. More particularly, embodiments of the inventive concept relate to a display apparatus and an electronic apparatus reducing a power consumption.

### 2. Description of the Related Art

Generally, a display apparatus includes a display panel and a display panel driver. The display panel includes a plurality of gate lines, a plurality of data lines, a plurality of emission lines and a plurality of pixels. The display panel driver includes a gate driver providing a gate signal to the gate lines, a data driver providing a data voltage to the data lines, an emission driver providing an emission signal to the emission lines and a driving controller controlling the gate driver, the data driver and the emission driver.

An emission efficiency of a light-emitting element of a pixel included in a display apparatus may be different according to a driving current.

### SUMMARY

Embodiments of the inventive concept provide a display apparatus in which an emission efficiency is improved and a power consumption is reduced.

Embodiments of the inventive concept also provide an electronic apparatus in which an emission efficiency is improved and a power consumption is reduced.

In an embodiment of the disclosure, a display apparatus may include a display panel including a plurality of pixels, a gate driver which outputs gate signals to the display panel, an emission driver which outputs an emission signal to the display panel, a data driver which applies data voltages to the display panel and a driving controller which controls the gate driver, the emission driver and the data driver. In a state in which a setting luminance of the display panel has a second setting luminance lower than a first setting luminance, an emission period in which the plurality of pixels emits may have a second emission period length longer than a first emission period length. An on-pixel ratio of the plurality of pixels may be changed based on the setting luminance.

In an embodiment, the plurality of pixels may emit light in response to the emission signal. In the second setting luminance, an on-duty ratio of the emission signal may have a second duty ratio higher than a first duty ratio, and the on-pixel ratio may have a second on-pixel ratio lower than a first on-pixel ratio.

In an embodiment, the plurality of pixels may include a first pixel, a second pixel, a third pixel and a fourth pixel. In the second on-pixel ratio, the first pixel and the second pixel may emit light, and the third pixel and the fourth pixel may stop emitting.

In an embodiment, in a state in which the setting luminance has a third setting luminance lower than the second setting luminance, the on-duty ratio may have a third duty ratio higher than the second duty ratio.

In an embodiment, the on-pixel ratio may have a third on-pixel ratio lower than the second on-pixel ratio.

In an embodiment, the plurality of pixels may include a first pixel, a second pixel, a third pixel and a fourth pixel. In the second on-pixel ratio, the first pixel emits light, and the second pixel, the third pixel and the fourth pixel may stop emitting.

In an embodiment, in the second setting luminance, a data voltage corresponding to the first setting luminance and a data voltage corresponding to the second setting luminance may be same as each other.

In an embodiment, at least one pixel of the plurality of pixels may include a driving transistor which generates a driving current based on a data voltage of the data voltages and a light-emitting element which emits light based on the driving current. In the second setting luminance, a first luminance driving current corresponding to the first setting luminance and a second luminance driving current corresponding to the second setting luminance among the data voltages may be same as each other.

In an embodiment, in the third setting luminance, a third luminance driving current corresponding to the third setting luminance may be lower than the second luminance driving current.

In an embodiment, at least one pixel of the plurality of pixels may include a driving transistor including a control electrode connected to a first node, a first electrode connected to a second node and a second electrode connected to a third node, a writing transistor which applies a data voltage of the data voltages to the first node in response to a write gate signal, an emission transistor which applies a first power voltage to the second node in response to the emission signal, a light-emitting element including a first electrode connected to the third node and a second electrode receiving a second power voltage.

In an embodiment, the display apparatus may further include a sweep signal generator which outputs a sweep signal to the display panel. The data driver may further output a pulse data voltage to the display panel. At least one pixel of the plurality of pixels may include a driving transistor which generates a driving current based on the data voltage, a sweep transistor which applies a first power voltage to a control electrode of the driving transistor based on the pulse data voltage and a light-emitting element which emits light based on the driving current. In the second setting luminance, the on-pixel ratio may have a second on-pixel ratio lower than a first on-pixel ratio.

In an embodiment, in the second setting luminance, the pulse data voltage may have a second pulse data voltage higher than a first pulse data voltage.

In an embodiment, in the first setting luminance, the sweep signal may be gradually decreased from a first high voltage to a first low voltage. In the second setting luminance, the sweep signal may be gradually decreased from a second high voltage higher than the first high voltage to the first low voltage.

In an embodiment of the disclosure, a display apparatus may include a display panel including a plurality of pixels and a display panel driver which drives the display panel as a normal mode or a low luminance mode. In the low luminance mode, a length of an emission period in which the plurality of pixels emit light may be increased, and an on-pixel ratio of the plurality of pixels may be decreased.

In an embodiment, the display panel driver may output an emission signal to the display panel. The plurality of pixels may emit light in response to the emission signal. In the low luminance mode, an on-duty ratio of the emission signal may have a second duty ratio higher than a first duty ratio, and the on-pixel ratio may have a second on-pixel ratio lower than a first on-pixel ratio.

In an embodiment, the display panel driver may apply a data voltage to the display panel. In the low luminance mode, a data voltage corresponding to the normal mode and a data voltage corresponding to the low luminance mode among the data voltages may be same as each other.

In an embodiment, the display panel driver may apply a data voltage of the data voltages to the display panel. At least one pixel of the plurality of pixels may include a driving transistor which generates a driving current based on the data voltage and a light-emitting element which emits light based on the driving current. In the low luminance mode, a first luminance driving current corresponding to a luminance of the normal mode and a second luminance driving current corresponding to a luminance of the low luminance mode may be same as each other.

In an embodiment, the display panel driver may output a data voltage of the data voltages, a pulse data voltage and a sweep signal to the display panel. At least one pixel of the plurality of pixels may include a driving transistor which generates a driving current based on the data voltage, a sweep transistor which applies a first power voltage to a control electrode of the driving transistor based on the pulse data voltage and a light-emitting element which emits light based on the driving current. In the low luminance mode, the on-pixel ratio may have a second on-pixel ratio lower than a first on-pixel ratio.

In an embodiment, in the low luminance mode, the pulse data voltage may have a second pulse data voltage higher than a first pulse data voltage, and the on-pixel ratio may have a second on-pixel ratio lower than a first on-pixel ratio.

In an embodiment, in the normal mode, the sweep signal may be gradually decreased from a first high voltage to a first low voltage. In the low luminance mode, the sweep signal may be gradually decreased from a second high voltage higher than the first high voltage to the first low voltage, and the on-pixel ratio may have a second on-pixel ratio lower than a first on-pixel ratio.

In an embodiment of the disclosure, an electronic apparatus may include a display panel including a plurality of pixels, a gate driver which outputs a gate signal to the display panel, an emission driver which outputs an emission signal to the display panel, a data driver which applies a data voltage to the display panel, a driving controller which controls the gate driver, the emission driver and the data driver based on an input control signal and a processor which outputs the input control signal. In a state in which a setting luminance of the display panel has a second setting luminance lower than a first setting luminance, an emission period in which the plurality of pixels emit may have a second emission period length longer than a first emission period length. An on-pixel ratio of the plurality of pixels may be changed based on the setting luminance.

As described above, in a state in which a setting luminance is decreased, an on-pixel ration of a display panel may be reduced, and a length of an emission period may be increased. Accordingly, the display panel may emit light as the setting luminance and a driving current applied to a light-emitting element may not be changed. The driving current applied to the light-emitting element may not be changed, so that an emission efficiency of the light-emitting element may be improved. Additionally, the on-pixel ratio may be reduced, so that a power consumption of a display apparatus may be reduced.

### BRIEF DESCRIPTION OF THE DRAWINGS

Illustrative, non-limiting embodiments will be more clearly understood from the following detailed description in conjunction with the accompanying drawings.

FIG. 1 is a block diagram illustrating an embodiment of a display apparatus according to the inventive concept.

FIG. 2 is a block diagram illustrating an on-pixel of a display panel of FIG. 1 in a first setting luminance.

FIG. 3 is a block diagram illustrating an on-pixel of a display panel of FIG. 1 in a second setting luminance.

FIG. 4 is a circuit diagram illustrating an embodiment of a pixel of FIG. 1.

FIG. 5 is a timing diagram illustrating a signal applied to a pixel of FIG. 4.

FIG. 6 is a timing diagram illustrating an emission signal outputted from an emission driver of FIG. 1.

FIG. 7 is a block diagram illustrating an on-pixel of a display panel of FIG. 1 in a third setting luminance.

FIG. 8 is a timing diagram illustrating an emission signal outputted from an emission driver of FIG. 1.

FIG. 9 is a graph illustrating a change of a driving current of a pixel of FIG. 4 based on a setting luminance.

FIG. 10 is a circuit diagram illustrating an embodiment of a pixel of FIG. 1.

FIG. 11 is a circuit diagram illustrating an embodiment of a pixel of FIG. 1.

FIG. 12 is a timing diagram illustrating signals applied to a pixel of FIG. 11.

FIG. 13 is a graph illustrating a pulse data voltage applied to a pixel of FIG. 11.

FIG. 14 is a graph illustrating a sweep signal applied to a pixel of FIG. 11.

FIG. 15 is a circuit diagram illustrating an embodiment of a pixel of FIG. 1.

FIG. 16 is a block diagram illustrating an embodiment of an electronic apparatus according to the inventive concept.

FIG. 17 is a diagram illustrating an embodiment in which the electronic apparatus of FIG. 16 is implemented as a smart phone.

FIG. 18 is a diagram illustrating an embodiment in which the electronic apparatus of FIG. 16 is implemented as a smart watch.

### DETAILED DESCRIPTION OF THE INVENTIVE CONCEPT

Hereinafter, the inventive concept will be explained in detail with reference to the accompanying drawings.

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it may be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” may therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” may, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). The term such as “about” may mean within one or more standard deviations, or within +30%, 20%, 10%, 5% of the stated value, for example.

The terms such as “controller” “generator” or “processor” as used herein is intended to mean a hardware component such as a circuitry that performs a predetermined function. The hardware component may include a field-programmable gate array (“FPGA”) or an application-specific integrated circuit (“ASIC”), for example. The software component may refer to an executable code and/or data used by the executable code in an addressable storage medium. Thus, the software components may be object-oriented software components, class components, and task components, and may include processes, functions, attributes, procedures, subroutines, segments of program code, drivers, firmware, micro codes, circuits, data, a database, data structures, tables, arrays, or variables, for example.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

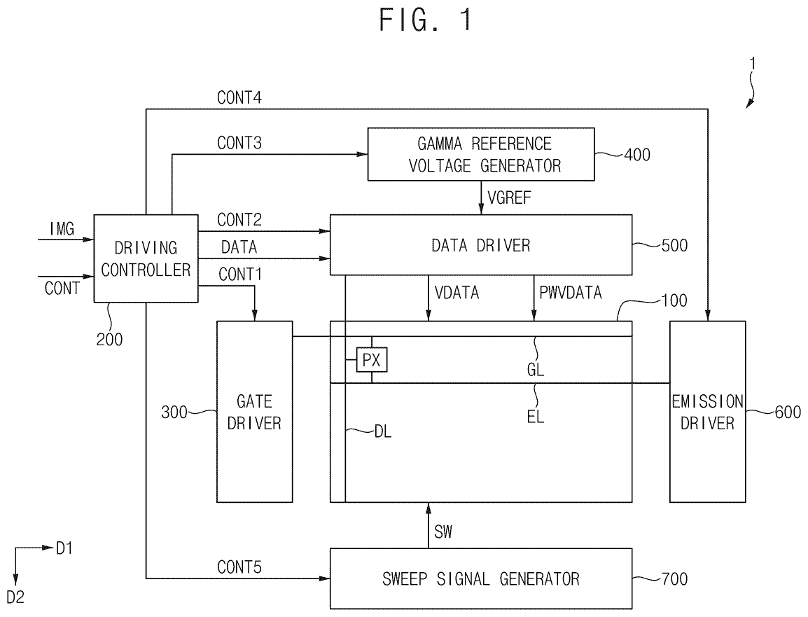

FIG. 1 is a block diagram illustrating an embodiment of a display apparatus 1 according to the inventive concept.

Referring to FIG. 1, the display apparatus 1 may include a display panel 100 and a display panel driver. The display panel driver may include a driving controller 200, a gate driver 300, a gamma reference voltage generator 400, a data driver 500 and an emission driver 600. In an embodiment, the display apparatus 1 may further include a sweep signal generator 700.

The display panel 100 may have a display region on which an image is displayed and a peripheral region next (adjacent) to the display region.

The display panel 100 may include a plurality of gate lines GL, plurality of emission lines EL, a plurality of data lines DL and a plurality of pixels PX electrically connected to the gate lines GL, the emission lines EL and the data lines DL. The gate lines GL may extend in a first direction D1, the emission lines EL may extend in the first direction D1 and the data lines DL may extend in a second direction D2 crossing the first direction D1.

The driving controller 200 may receive input image data IMG and an input control signal CONT from an external apparatus. In an embodiment, the input image data IMG may include red image data, green image data and blue image data, for example. The input image data IMG may include white image data. The input image data IMG may include magenta image data, cyan image data and yellow image data. The input control signal CONT may include a master clock signal and a data enable signal. The input control signal CONT may further include a vertical synchronizing signal and a horizontal synchronizing signal.

The driving controller 200 may generate a first control signal CONT1, a second control signal CONT2, a third control signal CONT3, a fourth control signal CONT4 and a data signal DATA based on the input image data IMG and the input control signal CONT. In an embodiment, the driving controller 200 may further generate a fifth control signal CONT5.

The driving controller 200 may generate the first control signal CONT1 for controlling an operation of the gate driver 300 based on the input control signal CONT, and output the first control signal CONT1 to the gate driver 300. The first control signal CONT1 may include a vertical start signal and a gate clock signal.

The driving controller 200 may generate the second control signal CONT2 for controlling an operation of the data driver 500 based on the input control signal CONT, and output the second control signal CONT2 to the data driver 500. The second control signal CONT2 may include a horizontal start signal and a load signal.

The driving controller 200 may generate the data signal DATA based on the input image data IMG. The driving controller 200 may output the data signal DATA to the data driver 500.

The driving controller 200 may generate the third control signal CONT3 for controlling an operation of the gamma reference voltage generator 400 based on the input control signal CONT, and output the third control signal CONT3 to the gamma reference voltage generator 400.

The driving controller 200 may generate the fourth control signal CONT4 for controlling an operation of the emission driver 600 based on the input control signal CONT, and output the fourth control signal CONT4 to the emission driver 600.

In an embodiment, the driving controller 200 may generate the fifth control signal CONT5 for controlling an operation of the sweep signal generator 700 based on the input control signal CONT, and output the fifth control signal CONT5 to the sweep signal generator 700.

The gate driver 300 may generate gate signals driving the gate lines GL in response to the first control signal CONT1 received from the driving controller 200. The gate driver 300 may output the gate signals to the gate lines GL.

In an embodiment, the gate driver 300 may be disposed in the peripheral region. In an embodiment, the gate driver 300 may be integrated in the peripheral region.

The gamma reference voltage generator 400 generates a gamma reference voltage VGREF in response to the third control signal CONT3 received from the driving controller 200. The gamma reference voltage generator 400 provides the gamma reference voltage VGREF to the data driver 500. The gamma reference voltage VGREF has a value corresponding to a level of the data signal DATA.

In an embodiment, the gamma reference voltage generator 400 may be disposed in the driving controller 200, or in the data driver 500.

The data driver 500 receives the second control signal CONT2 and the data signal DATA from the driving controller 200, and receives the gamma reference voltages VGREF from the gamma reference voltage generator 400. The data driver 500 converts the data signal DATA into data voltages VDATA having an analog type using the gamma reference voltages VGREF. The data driver 500 outputs the data voltages VDATA to the data lines DL. In an embodiment, the data driver 500 may further output a pulse data voltage PWVDATA.

In an embodiment, the data driver 500 may be disposed in the peripheral region. In an embodiment, the data driver 500 may be integrated in the peripheral region.

The emission driver 600 may generate emission signal in response to the fourth control signal CONT4 received from the driving controller 200. The emission driver 600 may output the emission signal to the display panel 100.

In an embodiment, the emission driver 600 may be disposed in the peripheral region. In an embodiment, the emission driver 600 may be integrated in the peripheral region.

Although the gate driver 300 is disposed on a first side of the display panel 100, and the emission driver 600 is disposed on a second side of the display panel 100 in FIG. 1 for convenience of explanation, the inventive concept is not limited thereto. The gate driver 300 and the emission driver 600 may be disposed on the first side of the display panel 100. In an embodiment, the gate driver 300 and the emission driver 600 may be disposed on the peripheral region of the display panel 100 on the same side of the display region of the display panel 100, for example. In an embodiment, the gate driver 300 and the emission driver 600 may be formed integrally with each other, for example.

The sweep signal generator 700 may generate sweep signal SW in response to the fifth control signal CONT5 received from the driving controller 200. The sweep signal generator 700 may output the sweep signal SW to the display panel 100.

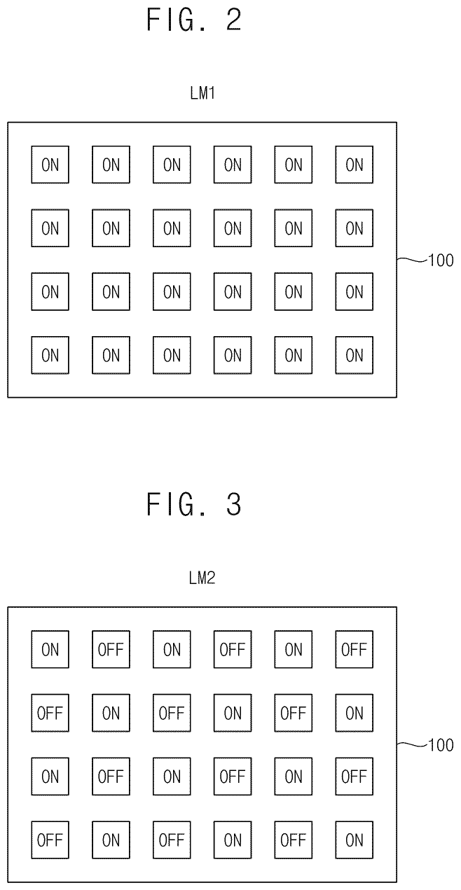

FIG. 2 is a block diagram illustrating an on-pixel of a display panel 100 of FIG. 1 in a first setting luminance LM1. FIG. 3 is a block diagram illustrating an on-pixel of a display panel 100 of FIG. 1 in a second setting luminance LM2.

Referring to FIG. 1 to FIG. 3, the display panel 100 may emit light based on a setting luminance. In an embodiment, the setting luminance may be a luminance set by user, for example. In an embodiment, the setting luminance may be a maximum luminance which the display panel 100 may emit light, for example. In an embodiment, the setting luminance may be a maximum luminance which the display panel 100 displays as a grayscale corresponding to white, for example. In an embodiment, the grayscale corresponding to white may be about 255 grayscale, for example. However, the inventive concept is not limited to a value of the grayscale corresponding to white. In an embodiment, the setting luminance may be about 3000 nits, for example. In an embodiment, the setting luminance may be about 600 nits, for example. However, the inventive concept is not limited to a value of the setting luminance.

In an embodiment, in a first setting luminance LM1, all of the pixels PX may emit light, for example. In an embodiment, in the first setting luminance LM1, the data voltage VDATA may be applied to all of the pixels PX, for example. In an embodiment, in the first setting luminance LM1, the display panel 100 may emit as a first on-pixel ratio. In an embodiment, the first on-pixel ratio may be about 100%, for example. In an embodiment, the first setting luminance LM1 may be about 600 nits. However, the inventive concept is not limited to a value of the first setting luminance LM1, for example.

In an embodiment, in a second setting luminance LM2, some of the pixels PX may emit light, for example. The second setting luminance LM2 may be lower than the first setting luminance LM1. In an embodiment, the second setting luminance LM2 may be about 50 nits, for example. However, the inventive concept is not limited to a value of the second setting luminance LM2. In an embodiment, in the first setting luminance LM1, the data voltage VDATA may be applied to all of the pixels PX, for example. In an embodiment, in the first setting luminance LM1, the display panel 100 may emit as a first on-pixel ratio, for example. In an embodiment, the first on-pixel ratio may be about 100%, for example. In an embodiment, the first setting luminance LM1 may be about 600 nits, for example. However, the inventive concept is not limited to a value of the first setting luminance LM1, for example. In the second setting luminance LM2, others of pixels PX may stop emitting. In an embodiment, remaining (the other) pixels PX may not receive the data voltage VDATA, for example. The display panel 100 may include a first pixel, a second pixel, a third pixel and a fourth pixel. In the second setting luminance LM2, the first pixel and the second pixel may emit light. In the second setting luminance LM2, the third pixel and the fourth pixel may stop emitting. In an embodiment, in the second setting luminance LM2, the display panel 100 may emit as a second on-pixel ratio. In an embodiment, the second on-pixel ratio may be about 50%, for example.

In the second setting luminance LM2, the first pixel may be an on-state. In an embodiment, the third pixel may be disposed next (adjacent) to the first pixel in the first direction D1, for example. In the second setting luminance LM2, the third pixel may be an off-state. In an embodiment, the fourth pixel may be disposed next (adjacent) to the first pixel in the second direction D2, for example. In the second setting luminance LM2, the fourth pixel may be an off-state. In an embodiment, the second pixel may be disposed next (adjacent) to the third pixel in the second direction D2, for example. In the second setting luminance LM2, the second pixel may be an on-state.

In the illustrated embodiment, the display panel 100 may have a different on-pixel ratio based on the setting luminance. In an embodiment, based on the setting luminance, remaining (the other) pixels PX may stop emitting, for example. Accordingly, a power consumption of the display apparatus 1 may be reduced.

In an embodiment, the display panel may be driven as a normal mode or a low luminance mode. In an embodiment, a setting luminance of the low luminance mode may be lower than a setting luminance of the normal mode, for example. In an embodiment, the low luminance mode may refer to as an always-on-display (“AOD”) mode, for example. In an embodiment, in the normal mode, the display panel 100 may be driven as the first setting luminance LM1, for example. In an embodiment, in the low luminance mode, the display panel 100 may be driven as the second setting luminance LM2, for example.

In an embodiment, in the normal mode, the display panel 100 may be emit as the first on-pixel ratio, for example. In an embodiment, in the low luminance mode, the display panel 100 may emit as the second on-pixel ratio, for example. Accordingly, in the low luminance mode, a power consumption of the display apparatus 1 may be reduced.

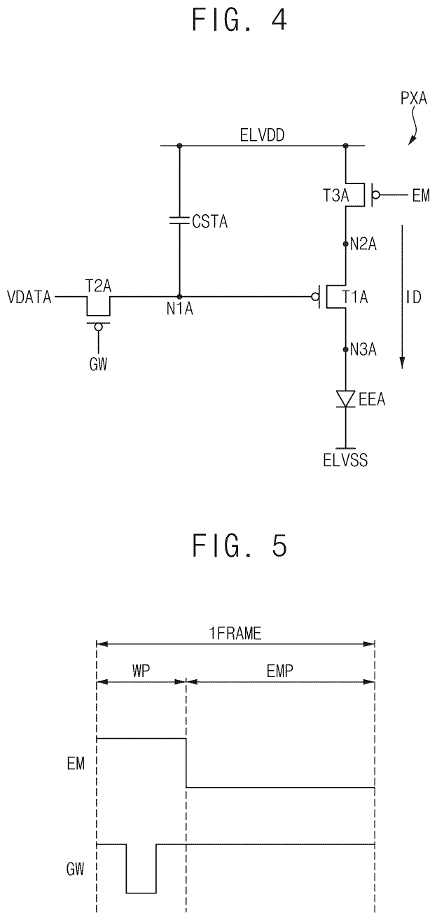

FIG. 4 is a circuit diagram illustrating an embodiment of a pixel PX of FIG. 1. FIG. 5 is a timing diagram illustrating a signal applied to a pixel PXA of FIG. 4.

Referring to FIG. 1 to FIG. 4, the pixel PXA may include a first transistor TIA, a second transistor T2A, a third transistor T3A, a storage capacitor CSTA and a light-emitting element EEA.

The first transistor TIA may include a control electrode connected to a first node NIA, a first electrode connected to a second node N2A, a second electrode connected to a third node N3A. The first transistor TIA may generate a driving current ID based on a voltage of the first node NIA. In an embodiment, the first transistor T1 may be referred to as a driving transistor, for example.

The second transistor T2A may include a control electrode receiving a write gate signal GW, a first electrode receiving the data voltage VDATA and a second electrode connected to the first node NIA. The second transistor T2A may apply the data voltage VDATA to the first node NIA in response to the write gate signal GW. In an embodiment, the second transistor T2A may be referred to as a write gate transistor, for example.

The third transistor T3A may include a control electrode receiving the emission signal EM, a first electrode receiving a first power voltage ELVDD and a second electrode connected to the second node N2A. The third transistor T3A may apply the first power voltage ELVDD to the second node N2A in response to the emission signal EM. In an embodiment, the third transistor T3A may be referred to as an emission control transistor (also referred to as an emission transistor), for example.

The storage capacitor CSTA may include a first electrode receiving the first power voltage ELVDD and a second electrode connected to the first node NIA.

The light-emitting element EEA may include a first electrode connected to the third node N3A and a second electrode receiving the second power voltage ELVSS. The light-emitting element EEA may emit light based on the driving current ID.

A frame period in which the pixel PX is driven may include a writing period WP and an emission period EMP.

In the writing period WP, the write gate signal GW may have an activation level. In the writing period WP, the second transistor T2A may be turned on in response to the write gate signal GW. The second transistor T2A may be turned on, so that the data voltage VDATA may be applied to the first node NIA.

In the emission period EMP, the emission signal EM may have an activation level. In the emission period EMP, the third transistor T3A may be turned on in response to the emission signal EM. The third transistor T3A may be turned on, the first power voltage ELVDD may be applied to the second node N2A. Accordingly, the light-emitting element EEA may emit light based on the driving current ID.

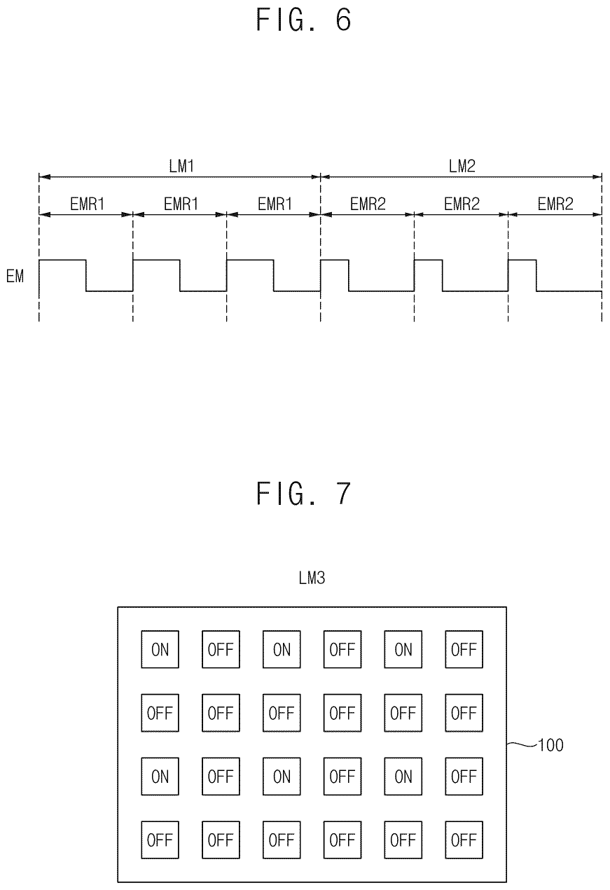

FIG. 6 is a timing diagram illustrating an emission signal EM outputted from an emission driver 600 of FIG. 1.

Referring to FIG. 1 to FIG. 6, a length of the emission period EMP based on the setting luminance. In an embodiment, an on-duty ratio of the emission signal EM may be changed based on the setting luminance of the display panel 100, for example.

In an embodiment, the on-duty ratio may mean a ratio between an activation level period of the emission signal EM and an inactivation level period of the emission signal EM, for example. In an embodiment, when a length of the activation level period of the emission signal EM and a length of the inactivation level period of the emission signal EM are same as each other, the on-duty ratio may be about 50%, for example. In an embodiment, when the length of the activation level period is increased, the on-duty ratio may be increased, for example.

In the first setting luminance LM1, the emission signal EM may have a first on-duty ratio EMR1. In the second setting luminance, the emission signal EM may have a second on-duty ratio EMR2 higher than the first on-duty ratio EMR1. Accordingly, the length of the emission period EMP may be increased in the second setting luminance LM2.

In the second setting luminance LM2, a data voltage VDATA corresponding to the first setting luminance LM1 and a data voltage VDATA corresponding to the second setting luminance LM2 may be same as each other. In an embodiment, in the second setting luminance LM2, a first luminance driving current corresponding to the first setting luminance LM1 and a second luminance driving current corresponding to the second setting luminance LM2 may be same as each other, for example. The first luminance driving current and the second luminance driving current may be same as each other, so that the driving current ID applied to the light-emitting element EEA may be same. The driving current ID applied to the light-emitting element EEA may be same, so that an emission efficiency of the light-emitting element EEA may be improved.

In the second setting luminance LM2, the display panel 100 may emit as the second on-pixel ratio. Additionally, in the second setting luminance, the length of the emission period EMP may be increased. Accordingly, the driving current ID may not be changed and the display panel 100 may emit as the second setting luminance LM2. The driving current ID may not be changed, so that an emission efficiency of the light-emitting element EEA may be improved. Additionally, the display panel 100 may emit as the second on-pixel ratio, so that a power consumption of the display apparatus 1 may be reduced.

In the normal mode, the emission signal EM may have a first on-duty ratio EMR1. In the low luminance mode, the emission signal EM may have a second on-duty ratio EMR2 higher than the first on-duty ratio EMR1. Accordingly, in the low luminance mode, the length of the emission period EMP may be increased.

In the low luminance mode, a data voltage corresponding to the normal mode and a data voltage corresponding to the low luminance mode may be substantially same as each other. In an embodiment, in the low luminance mode, a first luminance driving current corresponding to the normal mode and a second luminance driving current corresponding to the low luminance mode may be same as each other, for example. The first luminance driving current and the second luminance driving current may be same as each other, so that the driving current ID applied to the light-emitting element EEA may be same. the driving current ID applied to the light-emitting element EEA may be same, so that an emission efficiency of the light-emitting element EEA may be improved.

In the low luminance mode, the display panel 100 may emit as the second on-pixel ratio. Additionally, in the low luminance mode, the length of the emission period EMP may be increased. Accordingly, the driving current ID may not be changed and the display panel 100 may emit as the low luminance mode. The driving current ID may not be changed, so that an emission efficiency of the light-emitting element EEA may be improved. Additionally, the display panel 100 may emit as the second on-pixel ratio, so that a power consumption of the display apparatus 1 may be reduced.

FIG. 7 is a block diagram illustrating an on-pixel of a display panel 100 of FIG. 1 in a third setting luminance LM3.

In an embodiment, in a third setting luminance LM3, some of the pixels PX may emit light. The third setting luminance LM3 may be lower than the second setting luminance LM2, for example. Remaining (the other) pixels PX may stop emitting in the third setting luminance LM3. In an embodiment, the third setting luminance LM3 may be about 5 nits, for example. However, the inventive concept is not limited to a value of the third setting luminance LM3. In an embodiment, remaining (the other) pixels PX may not receive the data voltage VDATA, for example. The display panel 100 may include a first pixel, a second pixel, a third pixel and a fourth pixel. In the third setting luminance LM3, the first pixel may emit light. In the third setting luminance LM3, the second pixel, the third pixel and the fourth pixel may stop emitting. In an embodiment, in the third setting luminance LM3, the display panel 100 may emit as a third on-pixel ratio, for example. In an embodiment, the third on-pixel ratio may be about 25%, for example.

In the third setting luminance LM3, the first pixel may be an on-state. In an embodiment, the third pixel may be disposed next (adjacent) to the first pixel in the first direction D1, for example. In the third setting luminance LM3, the third pixel may be an off-state. In an embodiment, the fourth pixel may be disposed next (adjacent) to the first pixel in the second direction D2, for example. In the third setting luminance LM3, the fourth pixel may be an off-state. In an embodiment, the second pixel may be disposed next (adjacent) to the third pixel in the second direction D2. In the third setting luminance LM3, the second pixel may be an off-state, for example.

In the illustrated embodiment, the display panel 100 may have a different on-pixel ratio based on the setting luminance. In an embodiment, based on the setting luminance, remaining (the other) pixels PX may stop emitting. Accordingly, a power consumption of the display apparatus 1 may be reduced, for example.

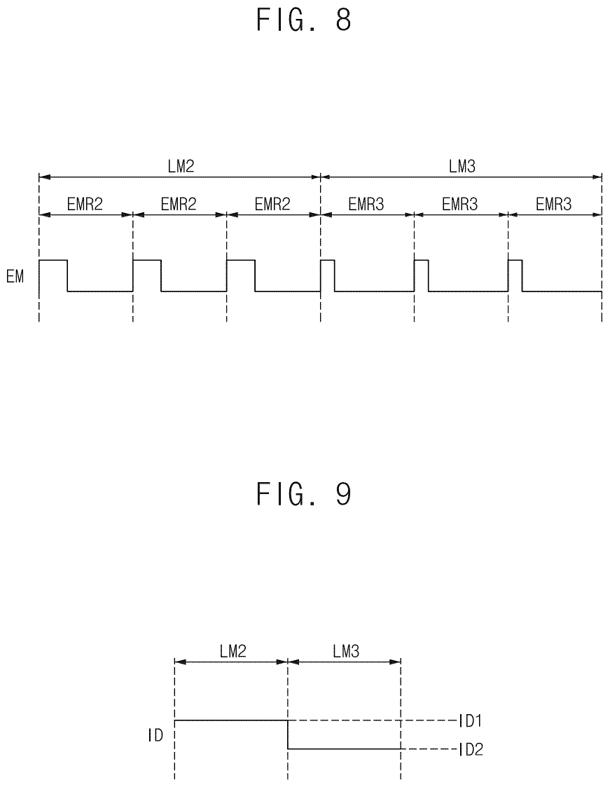

FIG. 8 is a timing diagram illustrating an emission signal EM outputted from an emission driver 600 of FIG. 1.

Referring to FIG. 1 to FIG. 8, in the third setting luminance LM3, the emission signal EM may have a third on-duty ratio EMR3 higher than the second on-duty ratio EMR2. Accordingly, the length of the emission period EMP may be further increased in the third setting luminance LM3.

In the third setting luminance LM3, a data voltage VDATA corresponding to the second setting luminance LM2 and a data voltage VDATA corresponding to the third setting luminance LM3 may be same as each other. In an embodiment, in the third setting luminance LM3, the second luminance driving current corresponding to the second setting luminance LM2 and a third luminance driving current corresponding to the third setting luminance LM3 may be same as each other, for example. The second luminance driving current and the third luminance driving current may be same as each other, so that the driving current ID applied to the light-emitting element EEA may be same. The driving current ID applied to the light-emitting element EEA may be same, so that an emission efficiency of the light-emitting element EEA may be improved.

In the third setting luminance LM3, the display panel 100 may emit as the third on-pixel ratio. Additionally, in the third setting luminance LM3, the length of the emission period EMP may be increased. Accordingly, the driving current ID may not be changed and the display panel 100 may emit as the third setting luminance LM3. The driving current ID may not be changed, so that an emission efficiency of the light-emitting element EEA may be improved. Additionally, the display panel 100 may emit as the third on-pixel ratio, so that a power consumption of the display apparatus 1 may be reduced.

FIG. 9 is a graph illustrating a change of a driving current ID of a pixel PXA of FIG. 4 based on a setting luminance.

Referring to FIG. 1 to FIG. 7 and FIG. 9, in the second setting luminance LM2, the light-emitting element EEA may emit light based on a first driving current ID1. In the third setting luminance LM3, the light-emitting element may emit light based on a second driving current ID2 lower than the first driving current ID1.

In the third setting luminance LM3, the display panel 100 may emit as the third on-pixel ratio. Additionally, in the third setting luminance LM3, the light-emitting element may emit light based on the second driving current ID2. Accordingly, the display panel 100 may emit as the third setting luminance LM3. In the third setting luminance LM3, the display panel 100 may emit as the third on-pixel ratio, a power consumption of the display apparatus 1 may be reduced.

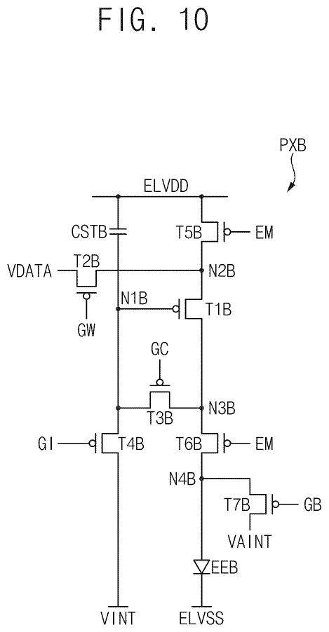

FIG. 10 is a circuit diagram illustrating an embodiment of a pixel PX of FIG. 1.

Referring to FIG. 10, a pixel PXB may include a first transistor T1B, a second transistor T2B, a third transistor T3B, a fourth transistor T4B, a fifth transistor T5B, a sixth transistor T6B, a seventh transistor T7B, a storage capacitor CSTB and a light-emitting element EEB.

The first transistor T1B may include a control electrode connected to a first node N1B, a first electrode connected to a second node N2B and a second electrode connected to a third node N3B. The first transistor TIB may generate a driving current based on a voltage of the first node N1B. In an embodiment, the first transistor T1B may be referred to as the driving transistor, for example.

The second transistor T2B may include a control electrode receiving the write gate signal GW, a first electrode receiving the data voltage VDATA and a second electrode connected to the first node NIB. The second transistor T2B may apply the data voltage VDATA to the first node NIB in response to the write gate signal GW. In an embodiment, the second transistor T2B may be referred to as the writing transistor, for example.

The third transistor T3B may include a control electrode receiving a compensation gate signal GC, a first electrode connected to the third node N3B and a second electrode connected to the first node NIB. The third transistor T3B may connect the first node NIB and the third node N3B in response to the compensation gate signal GC. In an embodiment, the third transistor T3B may be referred to as a compensating transistor, for example.

The fourth transistor T4B may include a control electrode receiving an initialization gate signal GI, a first electrode receiving an initialization voltage VINT and a second electrode connected to the first node NIB. The fourth transistor T4B may apply the initialization voltage VINT to the first node NIB in response to the initialization gate signal GI. In an embodiment, the fourth transistor T4B may be referred to as an initializing transistor, for example.

The fifth transistor T5B may include a control electrode receiving the emission signal EM, a first electrode receiving the first power voltage ELVDD and a second electrode connected to the second node N2B. The fifth transistor T5B may apply the first power voltage ELVDD to the second node N2B in response to the emission signal EM. In an embodiment, the fifth transistor T5B may be referred to as a first emission control transistor, for example.

The sixth transistor T6B may include a control electrode receiving the emission signal EM, a first electrode connected to the third node N3B and a second electrode connected to the fourth node N4B. The sixth transistor T6B may connect the third node N3B and the fourth node N4B in response to the emission signal EM. In an embodiment, the sixth transistor T6B may be referred to as a second emission control transistor, for example.

The seventh transistor T7B may include a control electrode receiving a bias gate signal GB, a first electrode receiving a light-emitting element initialization voltage VAINT and a second electrode connected to the fourth node N4B. The seventh transistor T7B may apply the light-emitting element initialization voltage VAINT to the fourth node N4B in response to the bias gate signal GB. In an embodiment, the seventh transistor T7B may be referred to as a light-emitting element initialization transistor, for example.

The storage capacitor CSTB may include a first electrode receiving the first power voltage ELVDD and a second electrode connected to the first node N1B.

The light-emitting element EEB may include a first electrode connected to the fourth node N4B and a second electrode receiving the second power voltage ELVSS. The light-emitting element EEB may emit light based on the driving current.

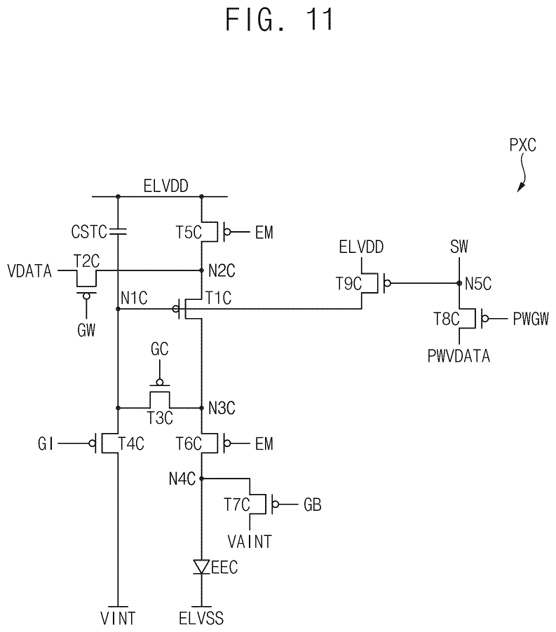

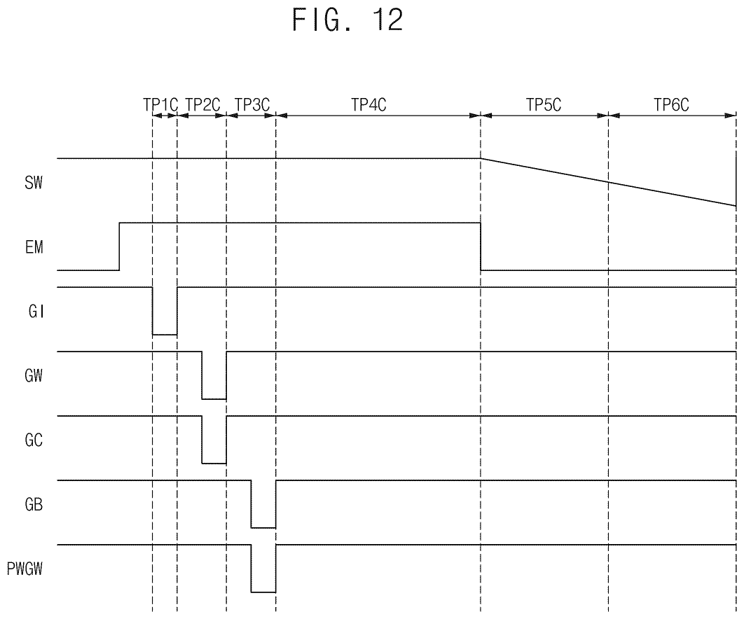

FIG. 11 is a circuit diagram illustrating an embodiment of a pixel PX of FIG. 1. FIG. 12 is a timing diagram illustrating signals applied to a pixel PXC of FIG. 11.

Referring to FIG. 11, a pixel PXC may include a first transistor TIC, a second transistor T2C, a third transistor T3C, a fourth transistor T4C, a fifth transistor T5C, a sixth transistor T6C, a seventh transistor T7C, an eighth transistor T8C, a ninth transistor T9C, a storage capacitor CSTC and a light-emitting element EEC.

The first transistor TIC may include a control electrode connected to a first node NIC, a first electrode connected to a second node N2C and a second electrode connected to a third node N3C. The first transistor TIC may generate a driving current based on a voltage of the first node NIC. In an embodiment, the first transistor TIC may be referred to as the driving transistor, for example.

The second transistor T2C may include a control electrode receiving the write gate signal GW, a first electrode receiving the data voltage VDATA and a second electrode connected to the first node NIC. The second transistor T2C may apply the data voltage VDATA to the first node NIC in response to the write gate signal GW. In an embodiment, the second transistor T2C may be referred to as the writing transistor, for example.

The third transistor T3C may include a control electrode receiving a compensation gate signal GC, a first electrode connected to the third node N3C and a second electrode connected to the first node NIC. The third transistor T3C may connect the first node NIC and the third node N3C in response to the compensation gate signal GC. In an embodiment, the third transistor T3C may be referred to as a compensating transistor, for example.

The fourth transistor T4C may include a control electrode receiving the initialization gate signal GI, a first electrode receiving the initialization voltage VINT and a second electrode connected to the first node NIC. The fourth transistor T4C may apply the initialization voltage VINT to the first node NIC in response to the initialization gate signal GI. In an embodiment, the fourth transistor T4C may be referred to as an initializing transistor, for example.

The fifth transistor T5C may include a control electrode receiving the emission signal EM, a first electrode receiving the first power voltage ELVDD and a second electrode connected to the second node N2C. The fifth transistor T5C may apply the first power voltage ELVDD to the second node N2C in response to the emission signal EM. In an embodiment, the fifth transistor T5C may be referred to as a first emission control transistor, for example.

The sixth transistor T6C may include a control electrode receiving the emission signal EM, a first electrode connected to the third node N3C and a second electrode connected to the fourth node N4C. The sixth transistor T6C may connect the third node N3C and the fourth node N4C in response to the emission signal EM. In an embodiment, the sixth transistor T6C may be referred to as a second emission control transistor, for example.

The seventh transistor T7C may include a control electrode receiving the bias gate signal GB, a first electrode receiving the light-emitting element initialization voltage VAINT and a second electrode connected to the fourth node N4C. The seventh transistor T7C may apply the light-emitting element initialization voltage VAINT to the fourth node N4C in response to the bias gate signal GB. In an embodiment, the seventh transistor T7C may be referred to as the light-emitting element initialization transistor, for example.

The eighth transistor T8C may include a control electrode receiving a pulse write gate signal PWGW, a first electrode receiving the pulse data voltage PWVDATA and a second electrode connected to a fifth node N5C. The eighth transistor T8C may apply the pulse data voltage PWVDATA to the fifth node N5C in response to the pulse write gate signal PWGW. In an embodiment, the eighth transistor T8C may be referred to as a pulse writing transistor, for example.

The ninth transistor T9C may include a control electrode connected to the fifth node N5C, a first electrode receiving the first power voltage ELVDD and a second electrode connected to the first node NIC. The ninth transistor T9C may apply the first power voltage ELVDD to the first node NIC in response to a voltage of the fifth node N5C. In an embodiment, the ninth transistor T9C may be referred to as a sweep transistor, for example.

The storage capacitor CSTC may include a first electrode receiving the first power voltage ELVDD and a second electrode connected to the first node NIC.

The light-emitting element EEC may include a first electrode connected to the fourth node N4B and a second electrode receiving the second power voltage ELVSS. The light-emitting element EEC may emit light based on the driving current.

Referring to FIG. 11 and FIG. 12, a frame period of the pixel PXC may include a first period TP1C, a second period TP2C, a third period TP3C, a fourth period TP4C, a fifth period TP5C and a sixth period TP6C.

In the first period TP1C, the emission signal EM may have an inactivation level, the initialization gate signal GI may have an activation level, a write gate signal GW may have an inactivation level, the bias gate signal GB may have an inactivation level and the pulse write gate signal PWGW may have an inactivation level.

In the first period TP1C, the fourth transistor T4C may be turned on in response to the initialization gate signal GI. The fourth transistor T4C may be turned on, so that the initialization voltage VINT may be applied to the first node NIC. In an embodiment, the first period TP1C may be referred to as an initialization period, for example.

In the second period TP2C, the emission signal EM may have an inactivation level, the initialization gate signal GI may have an inactivation level, a write gate signal GW may have an activation level, the bias gate signal GB may have an activation level and the pulse write gate signal PWGW may have an inactivation level.

In the second period TP2C, the second transistor T2C and the third transistor T3C may be turned on in response to the write gate signal GW. Accordingly, the data voltage VDATA may be applied to the first node NIC. In an embodiment, the second period TP2C may be referred to as a writing period, for example.

In the third period TP3C, the emission signal EM may have an inactivation level, the initialization gate signal GI may have an inactivation level, a write gate signal GW may have an inactivation level, the bias gate signal GB may have an activation level and the pulse write gate signal PWGW may have an activation level.

In the third period TP3C, the seventh transistor T7C may be turned on in response to the bias gate signal GB. Accordingly, the light-emitting element initialization voltage VAINT may be applied to the fourth node N4C. The third period TP3C may be referred to as an initialization period.

In the third period TP3C, the ninth transistor T9C may be turned on in response to the pulse write gate signal PWGW. Accordingly, the pulse data voltage PWVDATA may be applied to the fifth node N5C. In the illustrated embodiment, according to a voltage of the pulse data voltage PWVDATA, a turned off period of the ninth transistor T9C may be determined.

In the fourth period TP4C, the emission signal EM may have an inactivation level, the initialization gate signal GI may have an inactivation level, a write gate signal GW may have an inactivation level, the bias gate signal GB may have an inactivation level and the pulse write gate signal PWGW may have an inactivation level. The fourth period TP4C may be referred to as an emission signal waiting period.

In the fifth period TP5C, the sweep signal SW may be gradually decreased from a first high voltage, the emission signal EM may have an activation level, the initialization gate signal GI may have an inactivation level, a write gate signal GW may have an inactivation level, the bias gate signal GB may have an activation level and the pulse write gate signal PWGW may have an activation level.

In the fifth period TP5C, the fifth transistor T5C and the sixth transistor T6C may be turned on in response to the emission signal EM. In the fifth period TP5C, a voltage of the fifth node N5C may be higher than a threshold voltage of the ninth transistor T9C, so that the ninth transistor T9C may be turned off. In an embodiment, the fifth period TP5C may be referred to as an emission-on period, for example.

In the sixth period TP6C, the sweep signal SW may be gradually decreased to a first low voltage, the emission signal EM may have an activation level, the initialization gate signal GI may have an inactivation level, a write gate signal GW may have an inactivation level, the bias gate signal GB may have an activation level and the pulse write gate signal PWGW may have an activation level.

In the sixth period TP6C, the sweep signal SW may be gradually decreased, so that a voltage of the fifth node N5C may be gradually decreased. When a voltage of the fifth node N5C is lower than the threshold voltage of the ninth transistor T9C, the ninth transistor T9C may be turned on. When the ninth transistor T9C is turned on, the first power voltage ELVDD may be applied to the first node NIC. Accordingly, the first transistor TIC may be turned off.

A time duration in which the ninth transistor T9C maintains a turned off state may be determined based on the pulse data voltage PWVDATA. In an embodiment, when the pulse data voltage PWVDATA has a first voltage, a time duration in which the ninth transistor T9C maintains a turned off state may be a first time duration, for example. In an embodiment, when the pulse data voltage PWVDATA has a second voltage higher than the first voltage, a time duration in which the ninth transistor T9C maintains a turned off state may be a time duration longer than the first time duration, for example.

Accordingly, a time duration in which the light-emitting element EE emits light may be controlled based on the pulse data voltage PWVDATA.

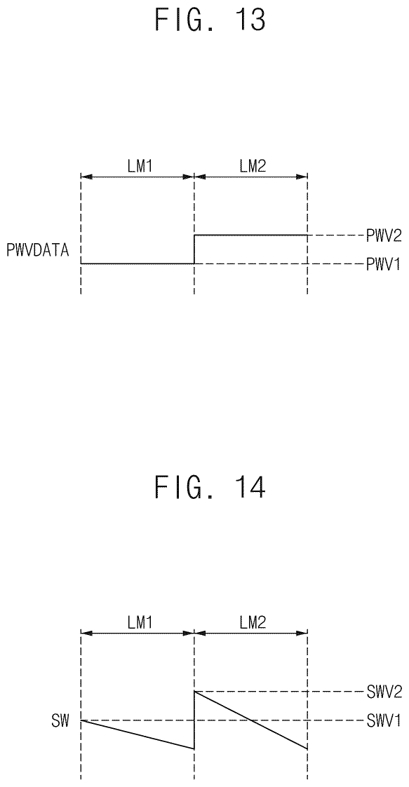

FIG. 13 is a graph illustrating a pulse data voltage PWVDATA applied to a pixel PXC of FIG. 11.

Referring to FIG. 1 to FIG. 3 and FIG. 11 to FIG. 13, in the first setting luminance LM1, a first pulse data voltage PWV1 may be applied to the pixel PSC. In the first setting luminance LM1, the pixel PXC may emit light during a first luminance time duration based to the first pulse data voltage PWV1. In the second setting luminance LM2, a second pulse data voltage PWV2 may be applied to the pixel PXC. The second pulse data voltage PWV2 may be higher than the first pulse data voltage PWV1. In the second setting luminance LM2, the pixel PXC may emit light during a second luminance time duration based to the second pulse data voltage PWV2. The second pulse data voltage PWV2 may be higher than the first pulse data voltage PWV1, the second luminance time duration may be longer than the first luminance time duration. Accordingly, the pixel may have a longer length of the emission period EMP in the second setting luminance LM2 than a length of the emission period EMP in the first setting luminance LM1. In the description, the length of the emission period EMP in the second setting luminance LM2 may be also referred to as a second emission period length, and the length of the emission period EMP in the first setting luminance LM1 may be also referred to a first emission period length.

In the second setting luminance LM2, a data voltage VDATA corresponding to the first setting luminance LM1 and a data voltage VDATA corresponding to the second setting luminance LM2 may be same as each other. In an embodiment, in the second setting luminance LM2, a first luminance driving current corresponding to the first setting luminance LM1 and a second luminance driving current corresponding to the second setting luminance LM2 may be same as each other, for example. The first luminance driving current and the second luminance driving current may be same as each other, so that the driving current applied to the light-emitting element EEC may be same. The driving current applied to the light-emitting element EEC may be same, so that an emission efficiency of the light-emitting element EEC may be improved.

In the second setting luminance LM2, the display panel 100 may emit as the second on-pixel ratio. Additionally, in the second setting luminance, the length of the emission period EMP may be increased. Accordingly, the driving current may not be changed and the display panel 100 may emit as the second setting luminance LM2. The driving current may not be changed, so that an emission efficiency of the light-emitting element EEC may be improved. Additionally, the display panel 100 may emit as the second on-pixel ratio, so that a power consumption of the display apparatus 1 may be reduced.

In the normal mode, the first pulse data voltage PWV1 may be applied to the pixel PXC. In the normal mode, the pixel PXC may emit light during the first luminance time duration based on the first pulse data voltage PWV1. In the low luminance mode, the second pulse data voltage PWV2 may be applied to the pixel PXC. In the low luminance mode, the pixel PXC may emit light during the second luminance time duration based on the second pulse data voltage PWV2. The first pulse data voltage PWV1 may be higher than the second pulse data voltage PWV2, so that the second luminance time duration may be longer than the first luminance time duration. Accordingly, in the low luminance mode, the length of the emission period EMP may be increased.

In the low luminance mode, a data voltage corresponding to the normal mode and a data voltage corresponding to the low luminance mode may be substantially same as each other. In an embodiment, in the low luminance mode, a first luminance driving current corresponding to the normal mode and a second luminance driving current corresponding to the low luminance mode may be same as each other, for example. The first luminance driving current and the second luminance driving current may be same as each other, so that the driving current applied to the light-emitting element EEC may be same. The driving current applied to the light-emitting element EEC may be same, so that an emission efficiency of the light-emitting element EEC may be improved.

In the low luminance mode, the display panel 100 may emit as the second on-pixel ratio. Additionally, in the low luminance mode, the length of the emission period EMP may be increased. Accordingly, the driving current may not be changed and the display panel 100 may emit as the low luminance mode. The driving current may not be changed, so that an emission efficiency of the light-emitting element EEA may be improved. Additionally, the display panel 100 may emit as the second on-pixel ratio, so that a power consumption of the display apparatus 1 may be reduced.

FIG. 14 is a graph illustrating a sweep signal SW applied to a pixel PXC of FIG. 11.

Referring to FIG. 1 to FIG. 3, FIG. 11, FIG. 12 and FIG. 14, in the first setting luminance LM1, the sweep signal SW may be gradually decreased from the first high voltage SWV1 to the first low voltage. In the first setting luminance LM1, the pixel PXC may emit light during the first luminance time duration. In the second setting luminance LM2, the sweep signal SW may be gradually decreased from a second high voltage SWV2 higher than the first high voltage SWV1 to the first low voltage. In the first setting luminance LM1, the pixel PXC may emit light during the second luminance time duration longer than the first luminance time duration. The second high voltage SWV2 may be higher than the first high voltage SWV1, the second luminance time duration may be longer than the first luminance time duration. Accordingly, the pixel may have a longer emission period EMP in the second setting luminance LM2 than the first setting luminance LM1.

In the second setting luminance LM2, a data voltage VDATA corresponding to the first setting luminance LM1 and a data voltage VDATA corresponding to the second setting luminance LM2 may be same as each other. In an embodiment, in the second setting luminance LM2, a first luminance driving current corresponding to the first setting luminance LM1 and a second luminance driving current corresponding to the second setting luminance LM2 may be same as each other, for example. The first luminance driving current and the second luminance driving current may be same as each other, so that the driving current applied to the light-emitting element EEC may be same. The driving current applied to the light-emitting element EEC may be same, so that an emission efficiency of the light-emitting element EEC may be improved.

In the second setting luminance LM2, the display panel 100 may emit as the second on-pixel ratio. Additionally, in the second setting luminance, the length of the emission period EMP may be increased. Accordingly, the driving current may not be changed and the display panel 100 may emit as the second setting luminance LM2. The driving current may not be changed, so that an emission efficiency of the light-emitting element EEA may be improved. Additionally, the display panel 100 may emit as the second on-pixel ratio, so that a power consumption of the display apparatus 1 may be reduced.

In the normal mode, the sweep signal SW may be gradually decreased from the first high voltage SWV1 to the first low voltage. In the normal mode, the pixel PXC may emit light during the first luminance time duration. In the low luminance mode, the sweep signal SW may be gradually decreased from the second high voltage SWV2 higher than the first high voltage SWV1 to the first low voltage. In the low luminance mode, the pixel PXC may emit light during the second luminance time duration. The second high voltage SWV2 may be higher than the first high voltage SWV1, so that the second luminance time duration may be longer than the first luminance time duration. Accordingly, in the low luminance mode, the length of the emission period EMP may be increased.

In the low luminance mode, a data voltage corresponding to the normal mode and a data voltage corresponding to the low luminance mode may be substantially same as each other. In an embodiment, in the low luminance mode, a first luminance driving current corresponding to the normal mode and a second luminance driving current corresponding to the low luminance mode may be same as each other, for example. The first luminance driving current and the second luminance driving current may be same as each other, so that the driving current applied to the light-emitting element EEC may be same. The driving current applied to the light-emitting element EEC may be same, so that an emission efficiency of the light-emitting element EEC may be improved.

In the low luminance mode, the display panel 100 may emit as the second on-pixel ratio. Additionally, in the low luminance mode, the length of the emission period EMP may be increased. Accordingly, the driving current may not be changed and the display panel 100 may emit as the low luminance mode. The driving current may not be changed, so that an emission efficiency of the light-emitting element EEA may be improved. Additionally, the display panel 100 may emit as the second on-pixel ratio, so that a power consumption of the display apparatus 1 may be reduced.

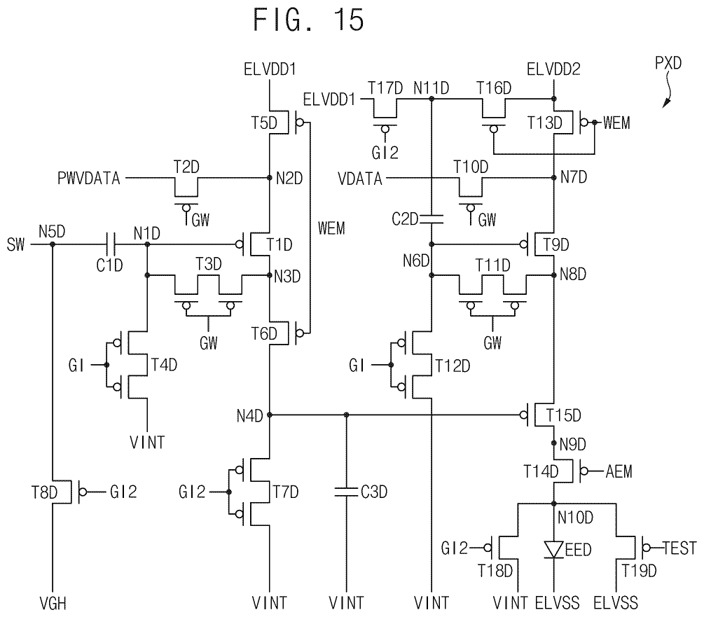

FIG. 15 is a circuit diagram illustrating an embodiment of a pixel PX of FIG. 1.

Referring to FIG. 15, a pixel PXD may include first to nineteenth transistors T1D, T2D, T3D, T4D, T5D, T6D, T7D, T8D, T9D, T10D, T11D, T12D, T13D, T14D, T15D, T16D, T17D, T18D and T19D, first to third capacitors C1D, C2D and C3D and a light-emitting element EED.

The first transistor T1D may include a control electrode connected to a first node N1D, a first electrode connected to a second node N2D and a second electrode connected to a third node N3D. The second transistor T2D may include a control electrode receiving the write gate signal GW, a first electrode receiving the pulse data voltage PWVDATA and a second electrode connected to the second node N2D. The third transistor T3D may include a control electrode receiving the write gate signal GW, a first electrode connected to the third node N3D and a second electrode connected to the first node N1D. In an embodiment, the third transistor T3D may include two series-connected transistors. The fourth transistor T4D may include a control electrode receiving a first initialization gate signal GI, a first electrode receiving the initialization voltage VINT and a second electrode connected to a first node N1D. In an embodiment, the fourth transistor T4D may include two series-connected transistors. The fifth transistor T5D may include a control electrode receiving a pulse emission signal WEM, a first electrode receiving the first power voltage ELVDD1 and a second electrode connected to the second node N2D. The sixth transistor T6D may include a control electrode receiving the pulse emission signal WEM, a first electrode connected to the third node N3D and a second electrode connected to a fourth node N4D. The seventh transistor T7D may include a control electrode receiving the first initialization gate signal GI, a first electrode receiving the initialization voltage VINT and a second electrode connected to the fourth node N4D. In an embodiment, the seventh transistor T7D may include two series-connected transistors. The eighth transistor T8D may include a control electrode receiving a second initialization gate signal GI2, a first electrode receiving a pixel high voltage VGH having a relatively high voltage level and a second electrode connected to a fifth node N5D. The ninth transistor T9D may include a control electrode connected to a sixth node N6D, a first electrode connected to a seventh node N7D and a second electrode connected to an eighth node N8D. The tenth transistor T10D may include a control electrode receiving the write gate signal GW, a first electrode receiving the data voltage VDATA and a second electrode connected to the seventh node N7D. The eleventh transistor T11D may include a control electrode receiving the write gate signal GW, a first electrode connected to the eighth node N8D and a second electrode connected to the sixth node N6D. The twelfth transistor T12D may include a control electrode receiving the initialization gate signal GI is applied, a first electrode receiving the initialization voltage VINT is applied and a second electrode connected to the sixth node N6D. The thirteenth transistor T13D may include a control electrode receiving the pulse emission signal WEM, a first electrode receiving a third power voltage ELVDD2 and a second electrode connected to the seventh node N7D. The fourteenth transistor T14D may include a control electrode receiving an emission signal AEM, a first electrode connected to a ninth node N9D and a second electrode connected to a tenth node N10D. The fifteenth transistor T15D may include a control electrode connected to the fourth node N4D, a first electrode connected to the eighth node N8D and a second electrode connected to the ninth node N9D. The sixteenth transistor T16D may include a control electrode receiving the pulse emission signal WEM, a first electrode connected to an eleventh node N11D and a second electrode connected to the control electrode of the thirteenth transistor T13D. The seventeenth transistor T17D may include a control electrode receiving the second initialization gate signal GI2, a first electrode receiving the first power voltage ELVDD1 and a second electrode connected to the eleventh node N11D. The eighteenth transistor T18D may include a control electrode receiving the second initialization gate signal GI2, a first electrode receiving the initialization voltage VINT and a second electrode connected to the tenth node N10D. The nineteenth transistor T19D may include a control electrode receiving a test signal TEST, a first electrode receiving the second power voltage ELVSS and a second electrode connected to the tenth node N10D. The first capacitor C1D may include a first electrode connected to the fifth node N5D and a second electrode connected to the first node N1D. The second capacitor C2D may include a first electrode connected to the eleventh node N11D and a second electrode connected to the sixth node N6D. The third capacitor C3D may include a first electrode receiving the initialization voltage VINT and a second electrode connected to the fourth node N4D. The light-emitting element EED may include a first electrode connected to the tenth node N10D and a second electrode receiving the second power voltage ELVSS.

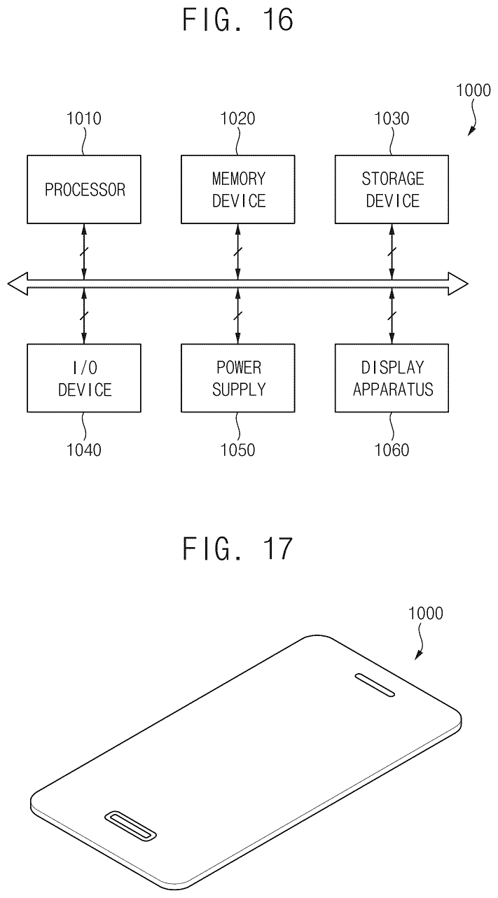

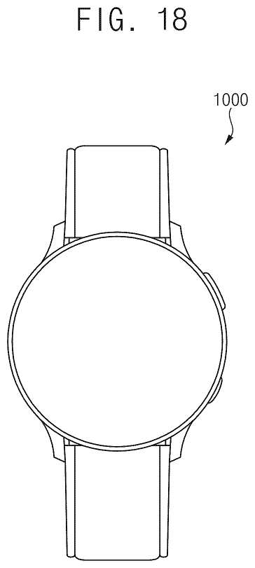

FIG. 16 is a block diagram illustrating an embodiment of an electronic apparatus 1000 according to the inventive concept. FIG. 17 is a diagram illustrating an embodiment in which the electronic apparatus of FIG. 16 is implemented as a smart phone.

Referring to FIG. 16, the electronic apparatus 1000 may include a processor 1010, a memory device 1020, a storage device 1030, an input/output (“I/O”) device 1040, a power supply 1050, and a display apparatus 1060. Here, the display apparatus 1060 may be the display apparatus of FIG. 1. Additionally, the electronic apparatus 1000 may further include a plurality of ports for communicating with a video card, a sound card, a memory card, a universal serial bus (“USB”) device, other electronic apparatus, etc.

In an embodiment, as illustrated in FIG. 17, the electronic apparatus 1000 may be implemented as a smart phone. However, the electronic apparatus 1000 is not limited thereto. In an embodiment, the electronic apparatus 1000 may be implemented as a cellular phone, a video phone, a smart pad, a smart watch, a tablet personal computer (“PC”), a car navigation system, a computer monitor, a laptop, a head mounted display (“HMD”) device, or the like, for example.

The processor 1010 may perform various computing functions or various tasks. The processor 1010 may be a micro-processor, a central processing unit (“CPU”), an application processor (“AP”), or the like. The processor 1010 may be coupled to other components via an address bus, a control bus, a data bus, etc. Further, the processor 1010 may be coupled to an extended bus such as a peripheral component interconnection (“PCI”) bus.

The processor 1010 may output the input image data IMG, the app-on signal and the input control signal CONT to the driving controller 200 of FIG. 1.

The memory device 1020 may store data for operations of the electronic apparatus 1000. In an embodiment, the memory device 1020 may include at least one non-volatile memory device such as an erasable programmable read-only memory (“EPROM”) device, an electrically erasable programmable read-only memory (“EEPROM”) device, a flash memory device, a phase change random access memory (“PRAM”) device, a resistance random access memory (“RRAM”) device, a nano floating gate memory (“NFGM”) device, a polymer random access memory (“PoRAM”) device, a magnetic random access memory (“MRAM”) device, a ferroelectric random access memory (“FRAM”) device, or the like and/or at least one volatile memory device such as a dynamic random access memory (“DRAM”) device, a static random access memory (“SRAM”) device, a mobile DRAM device, or the like, for example.

The storage device 1030 may include a solid state drive (“SSD”) device, a hard disk drive (“HDD”) device, a compact disc read-only memory (“CD-ROM”) device, or the like. The I/O device 1040 may include an input device such as a keyboard, a keypad, a mouse device, a touch-pad, a touch-screen, or the like and an output device such as a printer, a speaker, or the like. In some embodiments, the display apparatus 1060 may be included in the I/O device 1040. The power supply 1050 may provide power for operations of the electronic apparatus 1000. The display apparatus 1060 may be coupled to other components via the buses or other communication links.

Referring to FIG. 17, the electronic apparatus of the inventive concept is shown implemented as a smartphone, but the inventive concept is not limited thereto. The electronic apparatus may be a television, a monitor, a laptop computer, or a tablet. Additionally, the electronic apparatus may be a car.

FIG. 18 is a diagram illustrating an embodiment in which the electronic apparatus of FIG. 16 is implemented as a smart watch.

Referring to FIG. 16 and FIG. 18, the electronic device 1000 may be implemented as a smart watch. The smart watch may be an embodiment of the electronic device 1000 requiring an ultra-high resolution display panel.

The display apparatus in the embodiments may be applied to a display apparatus included in a computer, a notebook, a mobile phone, a smart phone, a smart pad, a portable media player (“PMP”), a personal digital assistance (“PDA”), a motion pictures expert group audio layer III (“MP3”) player, or the like.

The foregoing is illustrative of the inventive concept and is not to be construed as limiting thereof. Although a few embodiments of the inventive concept have been described, those skilled in the art will readily appreciate that many modifications are possible in the embodiments without materially departing from the novel teachings and advantages of the inventive concept. Accordingly, all such modifications are intended to be included within the scope of the inventive concept as defined in the claims. In the claims, means-plus-function clauses are intended to cover the structures described herein as performing the recited function and not only structural equivalents but also equivalent structures. Therefore, it is to be understood that the foregoing is illustrative of the inventive concept and is not to be construed as limited to the illustrative embodiments disclosed, and that modifications to the disclosed embodiments, as well as other embodiments, are intended to be included within the scope of the appended claims. The inventive concept is defined by the following claims, with equivalents of the claims to be included therein.

What is claimed is:

1. A display apparatus comprising:
a display panel including a plurality of pixels;
a gate driver configured to output gate signals to the display panel;
an emission driver configured to output an emission signal to the display panel;
a data driver configured to apply data voltages to the display panel; and
a driving controller configured to control the gate driver, the emission driver and the data driver,
wherein in a state in which a setting luminance of the display panel has a second setting luminance lower than a first setting luminance, an emission period in which the plurality of pixels emits has a second emission period length longer than a first emission period length, and
wherein an on-pixel ratio of the plurality of pixels is changed based on the setting luminance.

2. The display apparatus of claim 1, wherein the plurality of pixels emits light in response to the emission signal, and
wherein in the second setting luminance, an on-duty ratio of the emission signal has a second duty ratio higher than a first duty ratio, and the on-pixel ratio has a second on-pixel ratio lower than a first on-pixel ratio.

3. The display apparatus of claim 2, wherein the plurality of pixels includes a first pixel, a second pixel, a third pixel and a fourth pixel, and
wherein in the second on-pixel ratio, the first pixel and the second pixel emit light, and the third pixel and the fourth pixel stop emitting.

4. The display apparatus of claim 3, wherein in a state in which the setting luminance has a third setting luminance lower than the second setting luminance, the on-duty ratio has a third duty ratio higher than the second duty ratio.

5. The display apparatus of claim 4, wherein the on-pixel ratio has a third on-pixel ratio lower than the second on-pixel ratio.

6. The display apparatus of claim 5, wherein the plurality of pixels includes a first pixel, a second pixel, a third pixel and a fourth pixel, and
wherein in the second on-pixel ratio, the first pixel emits light, and the second pixel, the third pixel and the fourth pixel stop emitting.

7. The display apparatus of claim 4, wherein in the second setting luminance, a data voltage corresponding to the first setting luminance and a data voltage corresponding to the second setting luminance among the data voltages are same as each other.

8. The display apparatus of claim 4, wherein at least one pixel of the plurality of pixels includes:
a driving transistor configured to generate a driving current based on a data voltage of the data voltages; and
a light-emitting element configured to emit light based on the driving current, and
wherein in the second setting luminance, a first luminance driving current corresponding to the first setting luminance and a second luminance driving current corresponding to the second setting luminance are same as each other.

9. The display apparatus of claim 8, wherein in the third setting luminance, a third luminance driving current corresponding to the third setting luminance is lower than the second luminance driving current.

10. The display apparatus of claim 1, wherein at least one pixel of the plurality of pixels includes:
a driving transistor including a control electrode connected to a first node, a first electrode connected to a second node and a second electrode connected to a third node;
a writing transistor configured to apply a data voltage of the data voltages to the first node in response to a write gate signal among the gate signals;
an emission transistor configured to apply a first power voltage to the second node in response to the emission signal; and
a light-emitting element including a first electrode connected to the third node and a second electrode which receives a second power voltage.

11. The display apparatus of claim 1, further comprising:
a sweep signal generator configured to output a sweep signal to the display panel,
wherein the data driver further outputs a pulse data voltage to the display panel,
wherein at least one pixel of the plurality of pixels includes:
a driving transistor configured to generate a driving current based on a data voltage of the data voltages;
a sweep transistor configured to apply a first power voltage to a control electrode of the driving transistor based on the pulse data voltage; and
a light-emitting element configured to emit light based on the driving current, and
wherein in the second setting luminance, the on-pixel ratio has a second on-pixel ratio lower than a first on-pixel ratio.

12. The display apparatus of claim 11, wherein in the second setting luminance, the pulse data voltage has a second pulse data voltage higher than a first pulse data voltage.

13. The display apparatus of claim 11, wherein in the first setting luminance, the sweep signal is gradually decreased from a first high voltage to a first low voltage, and
wherein in the second setting luminance, the sweep signal is gradually decreased from a second high voltage higher than the first high voltage to the first low voltage.

14. A display apparatus comprising:
a display panel including a plurality of pixels; and
a display panel driver configured to drive the display panel as a normal mode or a low luminance mode,
wherein in the low luminance mode, a length of an emission period in which the plurality of pixels emits light is increased, and an on-pixel ratio of the plurality of pixels is decreased.

15. An electronic apparatus comprising:
a display panel including a plurality of pixels;
a gate driver configured to output a gate signal to the display panel;
an emission driver configured to output an emission signal to the display panel;
a data driver configured to apply a data voltage to the display panel;
a driving controller configured to control the gate driver, the emission driver and the data driver based on an input control signal; and
a processor configured to output the input control signal,
wherein in a state in which a setting luminance of the display panel has a second setting luminance lower than a first setting luminance, an emission period in which the plurality of pixels emits has a second emission period length longer than a first emission period length, and
wherein an on-pixel ratio of the plurality of pixels is changed based on the setting luminance.

16. The electronic apparatus of claim 15, wherein the plurality of pixels emits light in response to the emission signal, and
wherein in the second setting luminance, an on-duty ratio of the emission signal has a second duty ratio higher than a first duty ratio, and the on-pixel ratio has a second on-pixel ratio lower than a first on-pixel ratio.

17. The electronic apparatus of claim 16, wherein the plurality of pixels includes a first pixel, a second pixel, a third pixel and a fourth pixel, and
wherein in the second on-pixel ratio, the first pixel and the second pixel emit light, and the third pixel and the fourth pixel stop emitting.

18. The electronic apparatus of claim 17, wherein in a state in which the setting luminance has a third setting luminance lower than the second setting luminance, the on-duty ratio has a third duty ratio higher than the second duty ratio.

19. The electronic apparatus of claim 18, wherein the on-pixel ratio has a third on-pixel ratio lower than the second on-pixel ratio.

20. The electronic apparatus of claim 16, wherein the plurality of pixels includes a first pixel, a second pixel, a third pixel and a fourth pixel, and
wherein in the second on-pixel ratio, the first pixel emits light, and the second pixel, the third pixel and the fourth pixel stop emitting.
